(19) United States
(12) Patent Application Publication
(10) Pub. No.: US 2013/0128448 A1
(43) Pub. Date: May 23, 2013

(54) DIGITAL VIDEO RECORDER

(71) Applicants: Jong-Cheol Kim, Yongin-si (KR); Byung-Hun Park, Yongin-si (KR); In-Ho Kim, Gunpo-si (KR)

(72) Inventors: Jong-Cheol Kim, Yongin-si (KR); Byung-Hun Park, Yongin-si (KR); In-Ho Kim, Gunpo-si (KR)

(21) Appl. No.: 13/679,455

(22) Filed: Nov. 16, 2012

(30) Foreign Application Priority Data
Nov. 17, 2011 (KR) 10-2011-0120462

(51) Int. Cl. H04N 5/64; G06F 1/16

(52) U.S. Cl. CPC H04N 5/64; G06F 1/16
USPC 361/679.33

(57) ABSTRACT

A digital video recorder configured to enable a user to easily install or replace hard disk is provided. The digital video recorder includes a storage member comprising a connection terminal; a body member comprising a main board and an empty compartment configured to be concaved upward and fit the storage member so that the storage member is inserted into the empty compartment; a connector member disposed on an inner side of the body member and configured to be connected to the connection terminal of the storage member; and a tray member configured to be fixed to the storage member, wherein the storage member fixed to the tray member is moved toward the empty compartment of the body member in an upward-and-downward direction and moved toward the connector member in a forward-and-backward direction in a sliding manner, thereby making the connection terminal of the storage member coupled with the connector member.

### CROSS-REFERENCE TO RELATED APPLICATION

This application claims the benefit under 35 U.S.C. §119(a) of Korean Patent Application No. 10-2011-0120462, filed on Nov. 17, 2011, the disclosure of which is incorporated by reference in its entirety for all purposes.

### BACKGROUND

1. Field

The following description is related to a digital video recorder, and more specifically, to a digital video recorder used for recording a video.

2. Description of the Related Art

In the past, a video tape recorder which stores moving pictures in a video tape was commonly used as a video storage medium. However, the video tape has been replaced by hard disk which has mass storage, is inexpensive and boasts high processor speed. Due to this trend, demand for digital video recorders using hard disk as storage is increasing. A digital video recorder refers to a device which converts analog images photographed by an analog CCTV into digital images to store the converted images inside, or another device which stores digital images photographed using an IP camera. The digital video recorder not only converts a high-quality moving picture into a video compress format and stores the converted video, but also manages the moving picture in a form of a digital video file, so that a user is capable to watch and edit the video easily.

Korean Patent Publication No. 10-2010-0085731, published on Jul. 29, 2010, relates to a digital video recorder. The conventional digital video recorder commonly includes a main board, which is disposed inside of a body case, and hard disk, which is embedded in the main board inside of the body case. The conventional digital video recorder may be released in the market with or without hard disk. If a user purchases a digital video recorder without hard disk, the user should personally buy hard disk having a desired capacity, and then open a part of the body case to connect the hard disk and the main board.

Even in the case of a digital video recorder with hard disk embedded in the body case, the user needs to replace it with a new one having a large capacity when there is no more remaining capacity in hard disk.

However, when the user detaches the hard disk for replacement or installation, breakage may occur on the main board since the user could drop the hard disk on the main board mistakenly.

### SUMMARY

The present invention aims to provide a digital video recorder configured to enable a user to easily install or replace hard disk.

In order to achieve the above objective, the digital video recorder designed includes a storage member comprising a connection terminal; a body member comprising a main board and an empty compartment configured to be concaved upward and fitted enough for the storage member to be inserted; a connector member disposed on an inner side of the body member and configured to be connected to the connection terminal of the storage member; and the tray member configured to be fixed to the storage member, wherein the storage member fixed to the tray member is moved toward the empty compartment of the body member in an upward-and-downward direction and then moved toward the connector member in a forward-and-backward direction in a sliding manner, thereby making the connection terminal of the storage member coupled with the connector member.

### BRIEF DESCRIPTION OF THE DRAWINGS

FIG. 1 is a schematic diagram illustrating a digital video recorder according to an exemplary embodiment of the present invention;

FIGS. 2 and 3 are perspective views from different angles illustrating the digital video recorder shown in FIG. 1, in which a tray member is detached from a body member;

FIG. 4 is an exploded perspective view illustrating a storage member and a tray member which are detached from the digital video recorder shown in FIG. 1; and

FIG. 5 is an exploded perspective view illustrating the digital video recorder shown in FIG. 1.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will be suggested to those of ordinary skill in the art. Descriptions of well-known functions and structures are omitted to enhance clarity and conciseness.

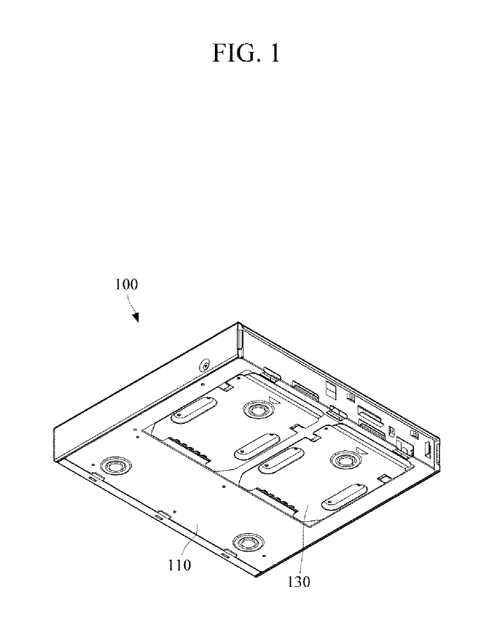

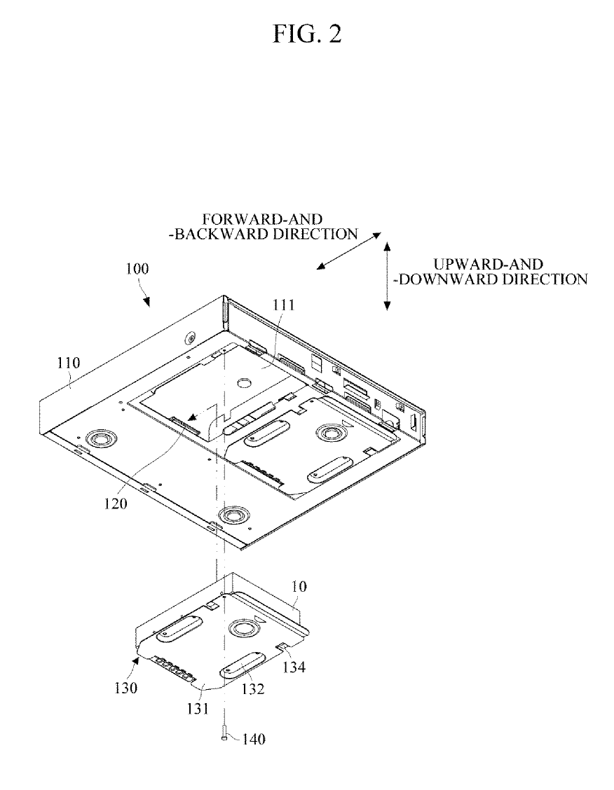

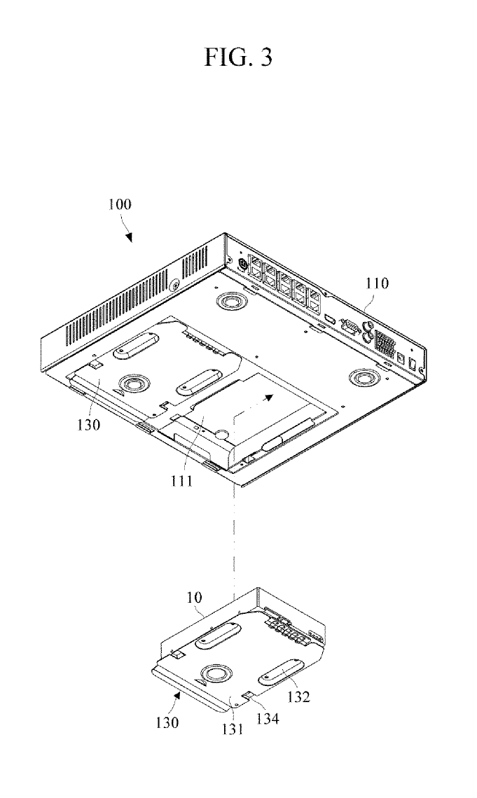

Referring to FIGS. 1 to 3, a digital video recorder 100 according to an exemplary embodiment of the present invention includes a body member 110, a connector member 120 and a tray member 130.

The body 100 is configured to surround a main board 101 disposed inside of the digital video recorder 100, and includes an empty compartment 111 configured to be concaved upward and fit a storage member 10 so that the storage member is inserted into the empty compartment 111. In a preferable embodiment of the present invention, the body member 110 surrounds the main board 101 to prevent the main board 101 from being exposed. At this time, the storage member 10 may be Hard Disk Drive (HDD) or Solid State Drive (SSD). The body member 110 may be in a hexahedral shape, but the configuration of the body member 110 is not limited thereto. Meanwhile, the empty compartment 111 may be disposed in the lower part of the body member 110. In this manner, the storage member 10 may be inserted into the empty compartment 111 so that the storage member is not exposed outward, thereby achieving a neater and tidier outward appearance of the digital video recorder.

The connector member 120 is configured to be formed on the inner side of the empty compartment 111 of the body member 110 and is electrically connected to the main board 101. When the storage member 10 is inserted into the empty compartment 111, the connector member 120 is coupled with a connection terminal 11 of the storage member 10. When the storage member 10 is inserted into the empty compartment 111, the connector member 120 and the connection terminal 11 of the storage member 10 are coupled with each other, so that the storage member 10 and the main board 101 are electrically coupled with each other.

The storage member 10 is fixed to one side of the tray member 130. With fixed to the tray member 130, the storage member 10 is moved toward the empty compartment 111 of the body member 110 in an upward-and-downward direction and then moved toward the connector member 120 in a forward-and-backward direction in a sliding manner, thereby leading the connection terminal 11 of the storage member 10 to be coupled with the connector member 120. That is, as the storage member 10 fixed to the tray member 130 is stably inserted into the empty compartment 111 by the upward-and-downward movement and the forward-and-backward sliding movement, the connection terminal 11 of the storage member 10 is coupled with the connector member 120.

In the above-described digital video recorder 110, the main board 101 is not exposed outward but surrounded by the body member 110. Hence, if a user mistakenly drops the storage member 10 on the body member 110 when inserting the storage member 10 into the body member 110, the body member 110 may be scratched but the main board 101 may be free from any breakage.

In addition, when the storage member 10 needs to be replaced, the user is able to pull only the tray member 130 out of the empty compartment 111, detach the storage member 10 from the tray member 130, then fix a new storage member 10 to the tray member 130, and insert the new storage member 10 fixed to the tray member 130 into the empty compartment 111.

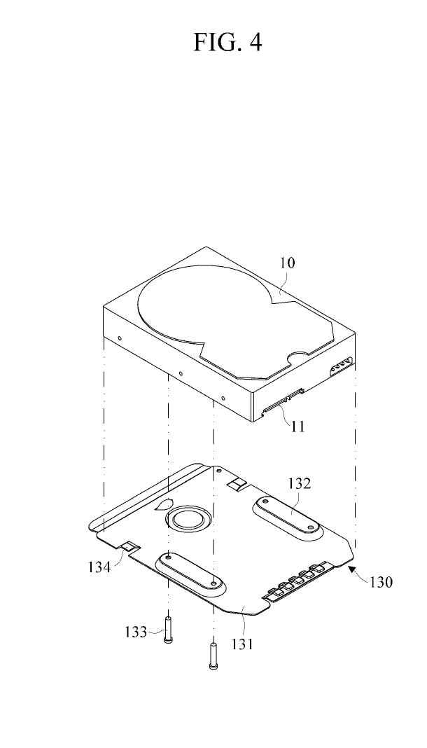

Referring to FIG. 4, the tray member 130 according to an exemplary embodiment of the present invention may include a base portion 131, a contact portion 132 and a first connection device 133.

The base portion 131 is composed of a sheet of a predetermined thickness that has a size corresponds to the size of the storage member 10.

The contact portion 132 is configured such that a part of the contact portion 132 protrudes on at least one part of the base portion 131 toward the storage member 10 to be in contact with one side of the storage member 10.

The first connection device 133 is configured to pass through the contact portion 132 to be connected to the storage member 10, thereby making the tray member 130 fixed to the storage member 10.

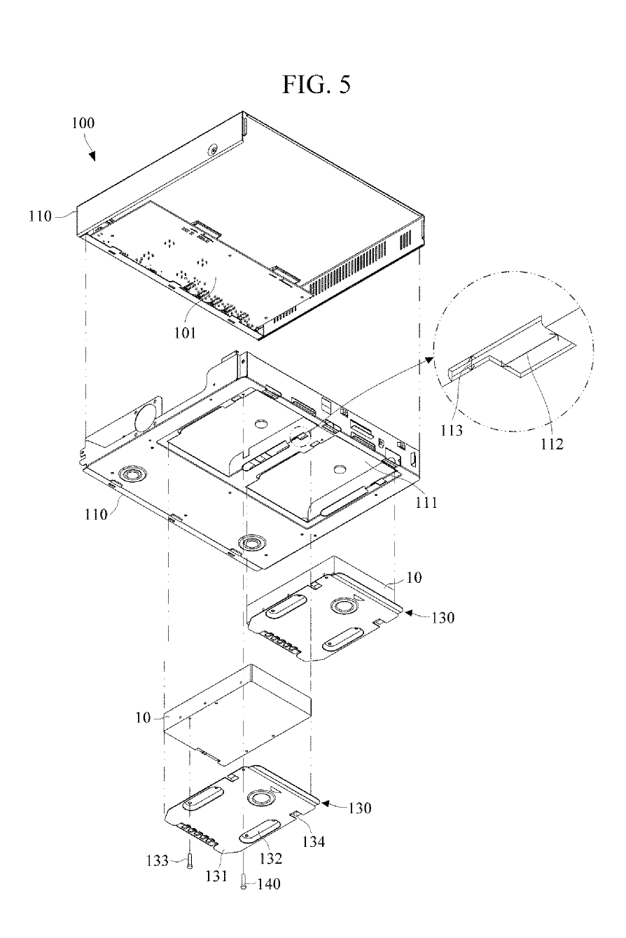

FIG. 5 is illustrated for a more specific explanation about the configuration of the digital video recorder 100, in which the storage member 10 fixed to the tray member 130 is able to be stably inserted into the empty compartment 111 by an upward-and-downward movement and a forward-and-backward sliding movement. In the digital video recorder 100, a protrusion 134 disposed on one side of the tray member 130 is configured to protrude upward by a predetermined length. In addition, the body member 110 may include a groove 112 and a guide portion 113. The groove 112 is caved on at least one surface surrounding the empty compartment 112 and has a size corresponding to the size of the protrusion 134. The guide portion 113 is extended by a predetermined length from the groove 112 toward the connector member 120 and guides the sliding movement of the tray member 130.

When the storage member 10 fixed to the tray member 130 is inserted into the empty compartment 111, the above-described configuration helps the protrusion 134 to be moved toward the groove 112 in an upward-and-downward direction and then moved along the guide portion 113 in a forward-and-backward direction in a sliding manner. In addition, the guide portion 113 may lead the tray member 130 and the storage member 10 to be moved in a predetermined track in a sliding manner. At this time, the storage member 10 goes with the tray member 130 since it is fixed to the tray member 130. In this manner, the connection terminal 11 of the storage member 10 may be correctly inserted into the connector member 120.

Meanwhile, the digital video recorder 100 according to an exemplary embodiment of the present invention may further include a second connection device 140. The second connection device 140 is configured to pass through the tray member 130 to be connected to the body member 110, so that the tray member 130 may be fixed to the body member 110. One of the examples of the second connection device 140 is a bolt.

In the digital video recorder according to an exemplary embodiment of the present invention, a main board is configured to be surrounded by a body member so as to be preventing from being exposed outward. Therefore, when a user drops a storage member on the body member while attempting to insert the storage member into the body member, the body member may be scratched but the main board may be free from any breakage.

In addition, when the storage member needs to be replaced, the user is able to pull only the tray member out of the empty compartment, detach the storage member from the tray member, fix a new storage member to the tray member and insert the tray member into the empty compartment.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A digital video recorder comprising:
a storage member comprising a connection terminal;
a body member comprising a main board and an empty compartment configured to be concaved upward and fit the storage member so that the storage member is inserted into the empty compartment;
a connector member disposed on an inner side of the body member and configured to be coupled with the connection terminal of the storage member; and
a tray member configured to be fixed to the storage member,
wherein the storage member fixed to the tray member is moved toward the empty compartment of the body member in an upward-and-downward direction and then moved toward the connector member in a forward-and-backward direction in a sliding manner, thereby making the connection terminal of the storage member coupled with the connector member.

2. The digital video recorder of claim 1, further comprising:
a protrusion disposed on one side of the tray member and configured to protrude upward by a predetermined length,
wherein the body member comprises
a groove configured to be caved on at least one surface surrounding the empty compartment and have a size corresponding to a size of the protruding portion; and
a guide portion configured to be extended by a predetermined length from the groove toward the connector member and guide a sliding movement of the tray member.

3. The digital video recorder of claim 1, wherein the tray member comprise
a base portion composed of a sheet of a predetermined thickness and of a size corresponding to a size of the storage member;
a contact portion configured to protrude on at least one part of the base portion toward the storage member to be in contact with one side of the storage member; and
a first connection device configured to pass through the contact portion to be connected to the storage member, thereby making the tray member fixed to the storage member.

4. The digital video recorder of claim 1, wherein the empty compartment is disposed in a lower part of the body member.

5. The digital video recorder of claim 1, further comprising:
a second connection member configured to pass through the tray member to be connected to the body member, thereby making the tray member fixed to the body member.
